(19) United States
(12) Patent Application Publication
(10) Pub. No.: US 2019/0090174 A1
(43) Pub. Date: Mar. 21, 2019

(54) VEHICLE AS PUBLIC WIRELESS HOTSPOT

(71) Applicant: FORD GLOBAL TECHNOLOGIES, LLC, Dearborn, MI (US)

(72) Inventors: Benjamin M. ROCCI, Ann Arbor, MI (US); Christian KROZAL, South Lyon, MI (US); Mark Anthony ROCKWELL, Wyandotte, MI (US); David Randolph ROBERTS, Dearborn, MI (US)

(21) Appl. No.: 15/707,166

(22) Filed: Sep. 18, 2017

(51) Int. Cl. H04W 48/02; G06Q 20/08; G06Q 30/02; H04W 12/06

(52) U.S. Cl. CPC H04W 48/02; G06Q 20/085; H04W 84/042; H04W 12/06; G06Q 30/0277

(57) ABSTRACT

A vehicle includes an embedded modem that includes with a cellular transceiver and a wireless network transceiver. The embedded modem is configured to communicate with a cellular network to provide internet access. The embedded modem is further configured to establish a private wireless network and authenticate devices connecting to a private wireless network to allow access to the cellular network. The embedded modem is further configured to establish a public wireless network in which data traffic is routed to a remote server over the cellular network for authentication and processing.

### TECHNICAL FIELD

This application generally relates to using a vehicle to provide public wireless network access.

### BACKGROUND

Portable electronic devices, such as computers and tablets, are widely used. These devices typically include wireless networking capability for connecting to an internet-enabled server. For example, many people have a wireless network connection in their home to provide internet access to the device. However, taking the devices outside of home presents the possibility of no internet access. Some establishments may provide wireless access for guests. Outside of these establishments, internet access may not be available.

### SUMMARY

A vehicle communication system includes a server in communication with a cellular network. The vehicle communication system further includes a vehicle modem configured to, communicate with the cellular network to provide internet access, establish a private wireless network allowing access to the cellular network responsive to receiving a private access key, and establish a public wireless network in which data traffic is routed to the server over the cellular network without presenting the private access key.

The vehicle modem may be configured to define a different Service Set Identifier (SSID) for private wireless network and the public wireless network. The server may have a predetermined internet protocol (IP) address and implement a web portal that is configured to control internet access for the public wireless network. The web portal may be further configured to request payment from a user of the public wireless network before allowing internet access. The web portal may be further configured to stream an advertisement to a device connected to the public wireless network before allowing internet access. The web portal may be further configured to periodically stream an advertisement to the device to maintain internet access. The server may be further configured to allocate at least a portion of revenue that results from providing internet access to the public wireless network to a vehicle owner. The server may be further configured to allocate at least a portion of revenue that results from providing internet access to the public wireless network to a cellular network provider. The server may be further configured to allocate at least a portion of revenue that results from providing internet access to the public wireless network to a vehicle manufacturer. The vehicle modem may be further configured to prioritize cellular network access for devices connected to the private wireless network.

A vehicle includes a modem, including a cellular transceiver and a wireless network transceiver, configured to, communicate with a cellular network to provide internet access, establish a private wireless network allowing access to the cellular network responsive to receiving a private access key, and establish a public wireless network in which data traffic is routed to a predetermined web portal over the cellular network without presenting the private access key.

The modem may be further configured to define a first Service Set Identifier (SSID) for the private wireless network and a second SSID that is different than the first SSID for the public wireless network. The modem may be further configured to prioritize message traffic directed to the private wireless network.

A method includes broadcasting, by a vehicle modem, identifiers for a public wireless network and a secure wireless network. The method further includes authenticating, by the vehicle modem, requests to access the secure wireless network. The method further includes transferring, by the vehicle modem, requests to access the public wireless network over a cellular network to a remote server for authentication and processing. The method further includes transferring, by the vehicle modem, internet data between the cellular network and each of the secure wireless network and the public wireless network responsive to successful authentication.

The method may further include authenticating, by the remote server, requests for internet access by requesting a user identification and a password. The method may further include authenticating, by the remote server, request for internet access by streaming an advertisement to a device that is requesting access. The method may further include distributing, by the remote server, a portion of revenue that is generated by providing internet access via the public wireless network to a vehicle owner. The method may further include distributing, by the remote server, a portion of revenue that is generated by providing internet access via the public wireless network to a vehicle manufacturer. Authenticating requests to access the secure wireless network may include receiving an encryption key and executing, by the vehicle modem, an encryption algorithm. The may further include prioritizing, by the vehicle modem, access to the cellular network for users connected to the secure wireless network.

### BRIEF DESCRIPTION OF THE DRAWINGS

FIG. 1 is a possible configuration of a vehicle communication system.

FIG. 2 is a possible configuration for an embedded modem in a vehicle.

FIG. 3 is a flowchart for a possible sequence of operations for providing a mobile wireless hotspot using a vehicle.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

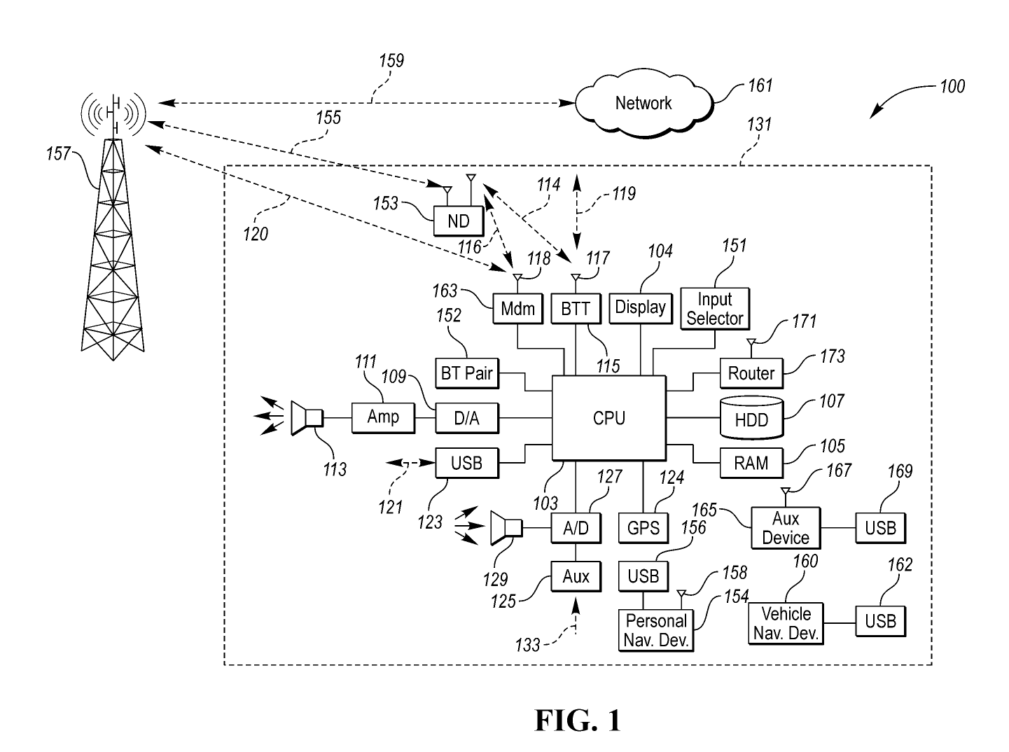

FIG. 1 illustrates an example block topology for a vehicle-based computing system 100 (VCS) for a vehicle 131. An example of such a vehicle-based computing system 100 is the SYNC system manufactured by THE FORD MOTOR COMPANY. The vehicle 131 enabled with the vehicle-based computing system 100 may contain a visual front end interface 104 located in the vehicle 131. The user may be able to interact with the interface 104 if it is provided, for example, with a touch sensitive screen. In another illustrative embodiment, the interaction occurs through, button presses, spoken dialog system with automatic speech recognition and speech synthesis.

In the illustrative embodiment shown in FIG. 1, at least one processor 103 controls at least some portion of the operation of the vehicle-based computing system 100. Provided within the vehicle 131, the processor 103 allows onboard processing of commands and routines. Further, the processor 103 is connected to both non-persistent 105 and persistent storage 107. In this illustrative embodiment, the non-persistent storage 105 is random access memory (RAM) and the persistent storage 107 is a hard disk drive (HDD) or flash memory. Non-transitory memory may include both persistent memory and RAM. In general, persistent storage 107 may include all forms of memory that maintain data when a computer or other device is powered down. These include, but are not limited to, HDDs, CDs, DVDs, magnetic tapes, solid state drives, portable USB drives and any other suitable form of persistent memory.

The processor 103 may also include a number of different inputs allowing the user and external systems to interface with the processor 103. The vehicle-based computing system 100 may include a microphone 129, an auxiliary input port 125 (for input 133), a Universal Serial Bus (USB) input 123, a Global Positioning System (GPS) input 124, a screen 104, which may be a touchscreen display, and a BLUETOOTH input 115. The VCS 100 may further include an input selector 151 that is configured to allow a user to swap between various inputs. Input from both the microphone 129 and the auxiliary connector 125 may be converted from analog to digital by an analog-to-digital (A/D) converter 127 before being passed to the processor 103. Although not shown, numerous of the vehicle components and auxiliary components in communication with the VCS may use a vehicle network (such as, but not limited to, a Controller Area Network (CAN) bus, a Local Interconnect Network (LIN) bus, a Media Oriented System Transport (MOST) bus, an Ethernet bus, or a FlexRay bus) to pass data to and from the VCS 100 (or components thereof).

Outputs from the processor 103 may include, but are not limited to, a visual display 104 and a speaker 113 or stereo system output. The speaker 113 may be connected to an amplifier 111 and receive its signal from the processor 103 through a digital-to-analog (D/A) converter 109. Outputs can also be made to a remote BLUETOOTH device such as a Personal Navigation Device (PND) 154 or a USB device such as vehicle navigation device 160 along the bi-directional data streams shown at 119 and 121 respectively.

In one illustrative embodiment, the system 100 uses the BLUETOOTH transceiver 115 with an antenna 117 to communicate with a user's nomadic device 153 (e.g., cell phone, smart phone, Personal Digital Assistance (PDA), or any other device having wireless remote network connectivity). The nomadic device 153 can then be used to communicate over a tower-network communication path 159 with a network 161 outside the vehicle 131 through, for example, a device-tower communication path 155 with a cellular tower 157. In some embodiments, tower 157 may be a wireless Ethernet or WiFi access point as defined by Institute of Electrical and Electronics Engineers (IEEE) 802.11 family of standards. Exemplary communication between the nomadic device 153 and the BLUETOOTH transceiver 115 is represented by Bluetooth signal path 114.

Pairing the nomadic device 153 and the BLUETOOTH transceiver 115 can be instructed through a button 152 or similar input. Accordingly, the CPU is instructed that the onboard BLUETOOTH transceiver 115 will be paired with a BLUETOOTH transceiver in a nomadic device 153.

Data may be communicated between CPU 103 and network 161 utilizing, for example, a data-plan, data over voice, or Dual Tone Multi Frequency (DTMF) tones associated with nomadic device 153. Alternatively, it may be desirable to include an onboard modem 163 having antenna 118 in order to establish a vehicle-device communication path 116 for communicating data between CPU 103 and network 161 over the voice band. The nomadic device 153 can then be used to communicate over the tower-network communication path 159 with a network 161 outside the vehicle 131 through, for example, device-tower communication path 155 with a cellular tower 157. In some embodiments, the modem 163 may establish a vehicle-tower communication path 120 directly with the tower 157 for communicating with network 161. As a non-limiting example, modem 163 may be a USB cellular modem and vehicle-tower communication path 120 may be cellular communication.

In one illustrative embodiment, the processor 103 is provided with an operating system including an application programming interface (API) to communicate with modem application software. The modem application software may access an embedded module or firmware on the BLUETOOTH transceiver 115 to complete wireless communication with a remote BLUETOOTH transceiver (such as that found in a nomadic device 153). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Other wireless communication means that can be used in this realm is free-space optical communication (such as IrDA) and non-standardized consumer IR protocols or inductive coupled means including but not limited to near-field communications systems such as RFID.

In another embodiment, nomadic device 153 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Division Multiple Access (CDMA), Time Division Multiple Access (TDMA), Space-Division Multiple Access (SDMA) for digital cellular communication, including but not limited to Orthogonal Frequency-Division Multiple Access (OFDMA) which may include time-domain statistical multiplexing. These are all International Telegraph Union (ITU) International Mobile Telecommunication (IMT) 2000 (3G) compliant standards and offer data rates up to 2 Mbps for stationary or walking users and 385 Kbps for users in a moving vehicle. 3G standards are now being replaced by IMT-Advanced (4G) which offers 100 Mbps for users in a vehicle and 1 Gbps for stationary users. If the user has a data-plan associated with the nomadic device 153, it is possible that the data-plan allows for broad-band transmission and the system could use a much wider bandwidth (speeding up data transfer). In still another embodiment, nomadic device 153 is replaced with a cellular communication device (not shown) that is installed to vehicle 131. In yet another embodiment, the nomadic device 153 may be a wireless local area network (LAN) device capable of communication over, for example (and without limitation), an IEEE 802.11g network (i.e., WiFi) or a WiMax network.

In one embodiment, incoming data can be passed through the nomadic device 153 via a data-over-voice or data-plan, through the onboard BLUETOOTH transceiver 115 and to the vehicle's internal processor 103. In the case of certain temporary data, for example, the data can be stored on the HDD or other storage media 107 until such time as the data is no longer needed.

Additional sources that may interface with the vehicle 131 include a personal navigation device 154, having, for example, a USB connection 156 and/or an antenna 158, a vehicle navigation device 160 having a USB 162 or other connection, an onboard GPS device 124, or remote navigation system (not shown) having connectivity to network 161. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU 103 may be in communication with a variety of other auxiliary devices 165. The auxiliary devices 165 can be connected through a wireless (e.g., via auxiliary device antenna 167) or wired (e.g., auxiliary device USB 169) connection. Auxiliary devices 165 may include, but are not limited to, personal media players, wireless health devices, portable computers, and the like.

Also, or alternatively, the CPU 103 may be connected to a vehicle-based wireless router 173, using for example a WiFi (IEEE 802.11) transceiver/antenna 171. This may allow the CPU 103 to connect to remote networks in range of the local router 173. In some configurations, the router 173 and the modem 163 may be combined as an integrated unit. However, features to be described herein may be applicable to configurations in which the modules are separate or integrated.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

As described, the vehicle-based computing system 100 may be configured to operate as a mobile wireless network hotspot. A wireless network hotspot may be a location at which a person may connect a portable device to obtain Internet access. As the vehicle is not tied to a geographical location, a mobile wireless network hotspot results. The mobile wireless network hotspot may be particularly useful to occupants of the vehicle. As the vehicle travels, occupants may enjoy wireless network connectivity via the cellular network. However, the wireless network hotspot provided by a vehicle does not typically benefit the public. For example, access to data may be metered or the vehicle owner may have a data-plan with a fixed amount of data. As such, access to the vehicle wireless network hotspot is typically carefully controlled by the vehicle owner. Communication with the wireless network hotspot may be through an encrypted channel and require an access code that may be defined and managed by the vehicle owner. As a result, public users do not have ready access to the mobile wireless network hotspot.

As wireless network hotspot capability is added to additional vehicles, it may be possible to improve public wireless network capability by making the vehicle wireless network hotspot available to the public. However, for such an access model to succeed, the wireless network hotspot must not impact the security, privacy, and cost for the vehicle owner. Further, incentives may be provided to make the provision of a public wireless network hotspot attractive to vehicle owners.

To facilitate the provision of a public wireless network hotspot, the vehicle 131 may be configured to provide a separate wireless network that is accessible by the public. The vehicle 131 may continue to provide a private network for the vehicle owner. In addition, both networks may communication to the cloud or network 161 via the cellular communication link.

When a user accesses the public network, message traffic may be routed to a unique path in the network or “cloud”. The public user may be routed to a predetermined Internet Protocol (IP) address. The predetermined IP address may be an address for a server that defines a web portal or web page. The server may be one or more computer systems that are connected to the network or “cloud.” The web portal may be implemented as a website using Hyper Text Markup Language (HTML), Cascading Style Sheets (CSS), JavaScript, and/or other web page building tools.

In some configurations, the cellular carrier may require payment or viewing of advertisements in exchange for accessing data over the cellular network. As such, the web portal may generate revenue that may be shared with the vehicle owner to create an incentive to participate in the mobile public wi-fi hotspot system. Further, the revenue may be shared with the original equipment manufacturer (OEM) (e.g., vehicle manufacturer) to provide an incentive for implementing public hotspot capability within vehicles. By sharing revenue that is generated, all parties may have incentive to provide public hotspot capability. At a minimum, compensation for covering expenses related to providing the public hotspot may be recovered.

The provision of public hotspot capability in vehicles may greatly expand public access to the internet. By implementing public hotspot capability in a large number of vehicles, public access to the internet may be provided in more areas.

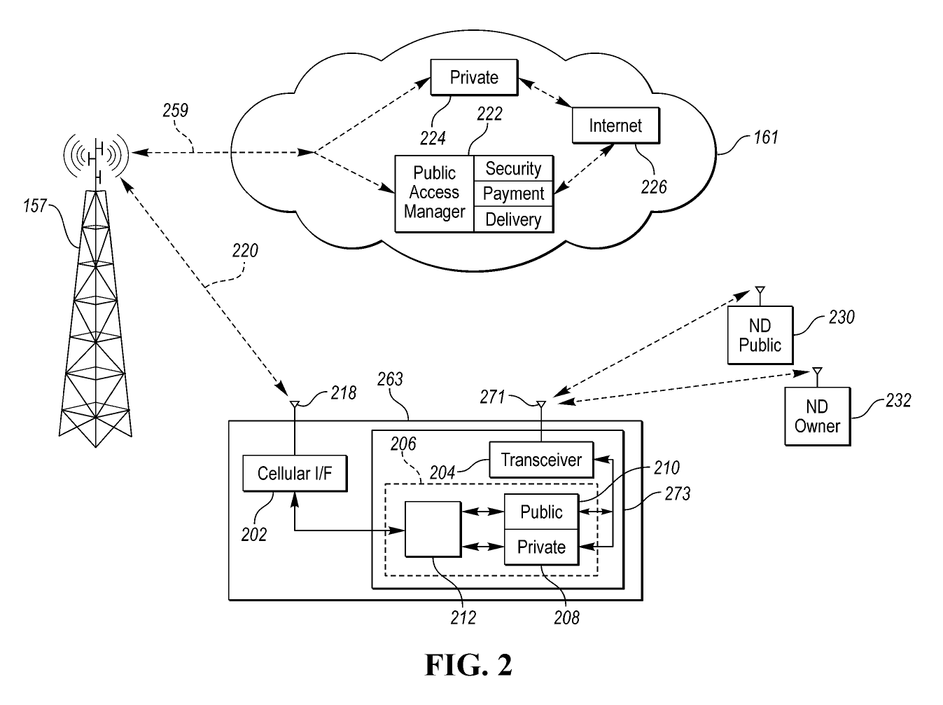

FIG. 2 depicts a block diagram of a possible configuration of an embedded modem 263 configured with wireless network and cellular network capability. The embedded modem 263 may include a cellular interface 202 that is configured to interface with the cellular tower 157. The cellular interface 202 may establish a modem-tower cellular communication channel 220 using an antenna 218 compatible with the cellular communication network. The embedded modem 263 may further include an integrated wireless network router 273. The embedded modem 263 may be connected to a wireless network antenna 271 that is configured to receive and transmit wireless signals. The embedded modem 263 may include a transceiver 204 that is configured to receive signals from the wireless network antenna 271 and convert the signals to digital messages that may be further processed. The transceiver 204 may be further configure to convert digital signals to be sent using the wireless network antenna 271.

The wireless network router 273 may further include a dual-SSID driver 206 that includes a communications management module 212 configured to manage signals passing between the cellular network and the wireless networks. For example, the communications management module 212 may transfer signals between the transceiver 204 and the cellular interface 202. The communication management module 212 may include a processor and associated volatile and non-volatile memory. The communication management module 212 may be configured to implement program instructions to manage and control the functions of the embedded modem 263.

The embedded modem 263 may include a cellular transceiver 202 (or cellular interface) that is configured to convert signals to a form for transmission over the modem-tower cellular communication channel 220. The cellular tower 157 may include a module to transfer data to the tower-network communication channel 259. For example, a module may convert the cellular data traffic to a wired network protocol (e.g., Ethernet).

A network may be defined by a Service Set Identifier (SSID) that is a unique identifier for the network. The SSID distinguishes a network from other overlapping networks in a given area. Users having network capable devices may view available network SSIDs and select a network to connect to from the list of available networks. Although a user may select a network, the user may not necessarily be able to connect to the selected network. For example, some networks may require login credentials (e.g., a user identifier and a password) before allowing the user to join the network. The network may implement one of several encryption and security algorithms. Examples include Wired Equivalent Privacy (WEP), Wi-Fi Protected Access (WPA), and Wi-Fi Protected Access II (WPA2). Networks that are configured with the security measures may requires a key before network access is granted. Without submission of the appropriate key, access to the network is not granted.

Public hotspot capability may be added to a vehicle by using a dual-SSID driver in the embedded modem 263. This makes it possible to define a public and a private wireless network. The dual-SSID driver creates a barrier that maintains privacy and security for the private network, while enabling public user data to pass through a different route in a cell service carrier cloud that is separate from the private network path. Each SSID defines a separate wireless network that may access the cellular network. Users connected to a given network defined by the SSID do not necessarily have access to the other networks. For example, a user connected to a public network SSID would be unable to view or access devices connected to the private network SSID.

The embedded modem 263 may further include a dual-SSID driver 206 that is configured to provide functionality for a public wireless network 210 and a private wireless network 208. The dual-SSID driver 206 may include hardware and software to determine the SSID of incoming and outgoing message traffic. The dual-SSID driver 206 may route messages intended for the specified SSID to the associated network. In addition, the dual-SSID driver 206 may determine the level of security or encryption level of the public wireless network 210 and the private wireless network 208. In some configurations, the level of security and/or encryption may be configured by the vehicle owner. For example, the desired encryption level and a private access key may be set by the vehicle owner/operator using the display interface 104.

The dual-SSID driver 206 may be configured to broadcast a public SSID and a private SSID via the wireless network antenna 271. Broadcast of the SSIDs may indicate that the networks are available for connection. The dual-SSID driver 206 may be configured to process requests to join the public network 210 and/or the private network 208. The dual-SSID driver 206 may manage the security and encryption to control access to each of the networks. For example, the private wireless network 208 may require an encryption scheme and the dual-SSID driver 206 may store an associated access key or password. An incoming request to join the private wireless network 208 may be authenticated by comparing the stored access key to a key provided by the device attempting to join the private wireless network 208. The stored access key may be a key that is configured and maintained by the vehicle owner. If the stored key and the provided key match, the device may be allowed access to the private wireless network 208. As the private wireless network 208 may be configured with a relatively high level of security, it may be referred to as a secure wireless network. An owner's nomadic device 232 or a device authorized by the owner may be able to connect to the private wireless network 208 as the owner can provide the private access key.

To facilitate access to the public wireless network 210 by a public nomadic device 230, the public wireless network 210 may be configured to be unencrypted. As such, access to the public wireless network 210 may be easily achieved by a public nomadic device 230. A device attempting to access the public wireless network 210 may be granted access without presenting the access key required for the private wireless network 208.

The dual-SSID driver 206 may further determine how messages are transferred to the cellular interface 202. For example, message traffic transferred over the private wireless network 208 may be routed to a private server 224 in the network 161. Alternatively, message traffic from the private wireless network 208 may be routed to the internet 226 directly. The dual-SSID driver 206 may be configured to authenticate requests to the private wireless network 208 as earlier described. As the access is locally authenticated by the embedded modem 263, no further measures may be desired.

Message traffic over the public wireless network 210 may be routed to a public access server 222. The public access server 222 may provide the authentication for accessing the network 161. The public access server 222 may be configured to provide network security, receive payment information, and deliver content to the devices connected to the public wireless network 210. Message traffic over the public wireless network 210 may be routed to a predetermined IP address that is associated with the public access server 222. For example, the communications management module 212 may be configured to store the predetermined IP address. When accessing the public wireless network 210, data may be routed to the predetermined IP address in the network 161. As the public wireless network 210 may be configured with no encryption scheme, the message traffic over the public wireless network 210 may be transferred over the cellular channel 220 to the public access server 222. The public access server 222 may be configured to authenticate any requests for network 161 access over the public wireless network 210. The public access server 222 may, for example, may determine the source of the requests and remember which devices are currently authenticated for internet access.

The public access server 222 associated with the predetermined IP address may implement a web portal. The public wireless network user may be required to pass through the web portal to gain further access (e.g., internet 226). The web portal may be configured to request payment for access via the public wireless network 210. For example, a payment screen may be presented to the user that requires that certain information be entered before granting further access to the network 161. User identification information along with a method of payment (e.g., credit card information) may be entered. In some payment schemes, users may pay a periodic subscription for access to the vehicle wireless network hotspot. In some configurations, users may gain access to the internet 226 by entering login information such as username and password. Access may be granted for a predetermined period of time. Upon expiration of the predetermined time period, a device requesting continued access to the internet may be required to re-authenticate. In other configurations, access may be for a predetermined amount of data. For example, a user may select to receive one gigabyte of data from the internet 226 over the public wireless network 210. When the predetermined amount of data has been delivered, the device requesting continued access to the internet may be required to re-authenticate. The public access server 222 may be configured to monitor the connection time and/or data usage for each device that is connected to the public wireless network 210.

In other payment configurations, further access to the network 161 may be contingent upon viewing advertisements. For example, when first accessing the public network 210, an advertisement may be streamed to the device requesting access. When the advertisement has been completed, access to the network 161 may be granted. In some configurations, the user may be required to view advertisements at a periodic interval to maintain access to the network 161.

A device may be authenticated or authorized to access the internet 226 via the public wireless network 210 after payment is verified and/or streaming of the advertisement is complete. The public access server 222 may maintain a history of devices that are presently authenticated or authorized for internet access 226. For example, the public access server 222 may monitor a media access control (MAC) address of each device that is requesting access to the internet 226. The MAC address may be uniquely assigned to any device having a network interface. The public access server 222 may maintain a table of MAC addresses for devices that are authorized for internet access. A new device connecting the public access server 222 may not have a MAC address stored in the table. In this case, the public access server 222 may initiate the authentication process for the new device.

Revenue may be generated for providing public internet access. As discussed, users may be required to submit payment for the internet access and usage. Users may alternatively be required to view advertisements. Advertisers may pay to have advertisements placed in the system. The provision for revenue generation may provide motivation for the various parties to provide the mobile hotspot system. The revenue that is generated by may be allocated and/or distributed between the cellular carrier, the vehicle owner, and the vehicle manufacturer. The revenue provides incentive for broad adoption of the mobile wireless hotspot system. Higher participation rates may further enhance the success of the mobile wireless hotspot system. By sharing the revenue, the affected parties can offset the cost of providing the mobile wireless hotspot system. Wide adoption may benefit the public as a greater number of wireless network hotspots will be available.

Vehicle owners may become discouraged if data access over the cellular network seems slow because of high public wireless network demand. The embedded modem 263 may be configured to prioritize message traffic destined for the private wireless network 208. For example, the integrated wireless network router 273 may be configured to give higher priority to data traffic of the private wireless network 208. The integrated wireless network router 273 may be configured to allocate a greater share of the cellular network bandwidth to the private wireless network 208. The integrated wireless network router 273 may monitor how the cellular network bandwidth is being used to ensure that the private wireless network 208 receives priority.

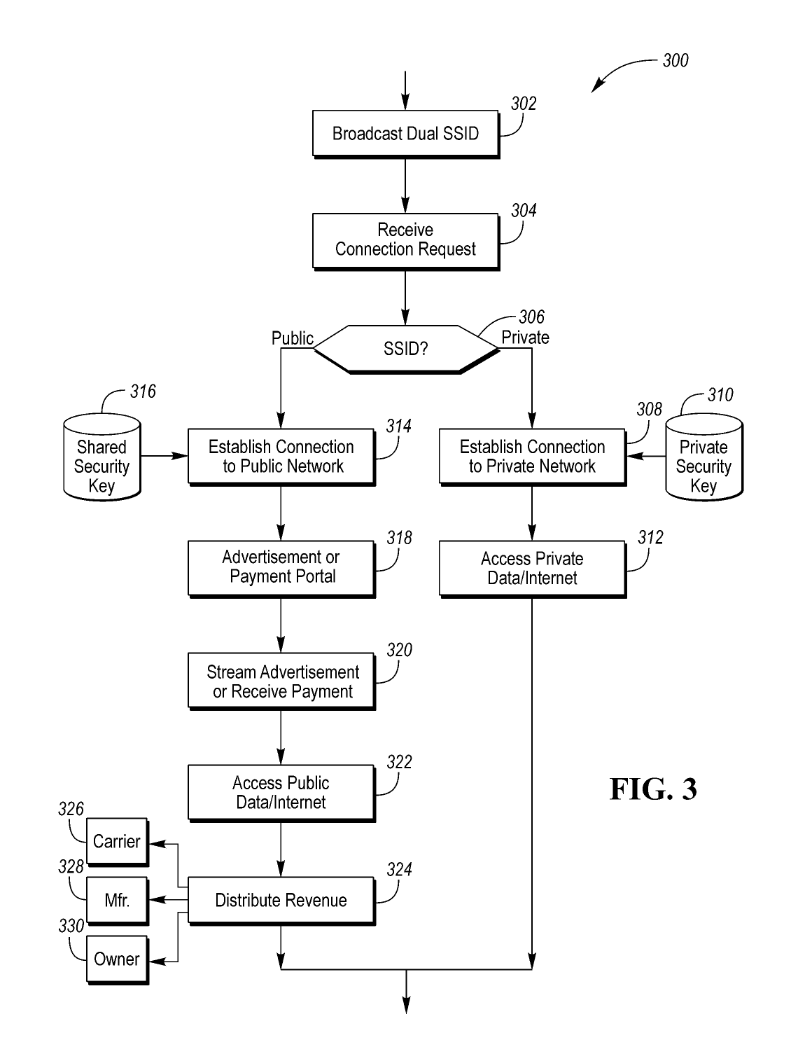

FIG. 3 depicts a flowchart 300 for a vehicle communication system that provides public and private wireless network access by a vehicle modem. At operation 302, the vehicle embedded modem 263 may broadcast identifiers for the public wireless network 210 and the private wireless network 208. The vehicle embedded modem/router 263 may broadcast the SSIDs associated with the private wireless network 208 and the public wireless network 210. At operation 304, the vehicle embedded modem 263 may receive a connection request. The connection request may include an SSID for the network to which a connection is desired and a MAC address of the device requesting access. At operation 306, the embedded modem 263 may determine which network the SSID is associated with. If the SSID is the private wireless network 210, operation 308 may be performed to establish a connection to the private wireless network 210. For example, any private security keys 310 or other authentication data may be retrieved and checked to ensure that the requestor has proper authorization to join the private network. At operation 312, access to the internet 226 and private wireless network 208 may be provided and data may be transferred between the cellular network and the private wireless network 208.

If the SSID is the public wireless network 210, operation 314 may be performed to establish a connection to the public network. In some configurations, there may be a shared security key 316 that the connecting user has knowledge of. For example, the public hotspots may be provided to subscribers of a cellular carrier which may distribute the key to subscribers. In some configurations, the messages received on the public wireless network 210 may be transferred to the public access server 222 for authentication and processing. At operation 318, the public access server 222 may execute a web portal that is configured to generate an advertisement or receive payment information. That is, when the private network connection is established, the user may be directed to a web portal at a predetermined internet address. The web portal may query the user for login information. For example, to access the public hotspots, the user may have an account that can be verified by entering a username and password. In some configurations, the web portal may query the user for payment information. The user may be required to enter a valid credit card number or other means of payment before data access is granted. In some configurations, data access may be contingent upon the user receiving an advertisement. At operation 320 the advertisement may be streamed to the user. Responsive to successful authentication, access to public data/internet may be available at operation 322. That is, internet data may be transferred between the cellular network and the public wireless network 210.

The network access may depend on the compensation model. If the compensation model is advertising based, the system may require that an advertisement be streamed at predetermined intervals. For example, the system may be configured to stream an advertisement to the user every 15 minutes. In pay-for-access models, the user may pay for a predetermined time or data amount. Once the time or data amount has been met, the user may be presented with the payment web portal. The network may be configured to track the amount of time that the user is connected to the network and further configured to monitor the amount of data passed between the network and the user.

At operation 324, revenue generated may be distributed to the various stakeholders. For example, any credit for streaming the advertisement may be distributed to accounts of the cellular carrier 326, the vehicle manufacturer 328, and the vehicle owner 330. The percentage of the distribution to each party may be varied over time.

The methods and systems described provide a model for expanding public wireless hotspots using vehicles. Public users may be able to access the public network through the vehicle interface without affecting the vehicle owner/operator usage. Further, the model provides incentives to maximize adoption of the vehicle-based wireless hotspot. By providing a mechanism for compensating the affected parties, widespread adoption may result.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

1. A vehicle communication system comprising:
a server in communication with a cellular communication channel and the internet, and configured to stream an advertisement in exchange for a predetermined amount of internet access; and
a vehicle modem configured to, communicate with the cellular network, connect a device to a private wireless network allowing internet access via the cellular network without communicating with the server responsive to receiving a corresponding private access key, and, otherwise, connect the device to a public wireless network in which data traffic is routed to the server over the cellular network and allowing internet access after the server streams the advertisement to the device.

2. The vehicle communication system of claim 1 wherein the vehicle modem is configured to define a different Service Set Identifier (SSID) for the private wireless network and the public wireless network.

3. The vehicle communication system of claim 1 wherein the server has a predetermined internet protocol (IP) address and implements a web portal that is configured to control internet access for the public wireless network.

4. The vehicle communication system of claim 3 wherein the web portal is further configured to request payment from a user of the public wireless network before allowing internet access.

5. (canceled)

6. The vehicle communication system of claim 3 wherein the web portal is further configured to periodically stream an advertisement to the device to maintain internet access.

7. The vehicle communication system of claim 1 wherein the server is further configured to allocate at least a portion of revenue that results from providing internet access to the public wireless network to a vehicle owner.

8. The vehicle communication system of claim 1 wherein the server is further configured to allocate at least a portion of revenue that results from providing internet access to the public wireless network to a cellular network provider.

9. The vehicle communication system of claim 1 wherein the server is further configured to allocate at least a portion of revenue that results from providing internet access to the public wireless network to a vehicle manufacturer.

10. The vehicle communication system of claim 1 wherein the vehicle modem is further configured to prioritize cellular communication channel access for devices connected to the private wireless network.

11. A vehicle comprising:
a modem, including a cellular transceiver and a wireless network transceiver, configured to, communicate through a cellular communication channel to provide internet access, connect a device to a private wireless network allowing internet access via the cellular communication channel responsive to receiving a private access key, and, otherwise, connect the device to a public wireless network in which data traffic is routed to a predetermined web portal over the cellular communication channel and allowing internet access after the web portal streams an advertisement to the device.

12. The vehicle of claim 11 wherein the modem is further configured to define a first Service Set Identifier (SSID) for the private wireless network and a second SSID that is different than the first SSID for the public wireless network.

13. The vehicle of claim 11 wherein the modem is further configured to prioritize message traffic directed to the private wireless network.

14. A method comprising:
by a vehicle modem,
broadcasting identifiers for a public wireless network and a secure wireless network;
authenticating requests to access the secure wireless network;
transferring requests to access the public wireless network over a cellular communication channel to a remote server that is configured to stream an advertisement in exchange for a predetermined amount of internet access; and
transferring internet data through the cellular communication channel to the secure wireless network responsive to successful authentication and to the public wireless network responsive to streaming the advertisement.

15. (canceled)

16. (canceled)

17. The method of claim 14 further comprising distributing, by the remote server, a portion of revenue that is generated by providing internet access via the public wireless network to a vehicle owner.

18. The method of claim 14 further comprising distributing, by the remote server, a portion of revenue that is generated by providing internet access via the public wireless network to a vehicle manufacturer.

19. The method of claim 14 wherein authenticating requests to access the secure wireless network includes receiving an encryption key and executing, by the vehicle modem, an encryption algorithm.

20. The method of claim 14 further comprising prioritizing, by the vehicle modem, access to the cellular network for users connected to the secure wireless network.
